(19) United States
(12) Patent Application Publication
(10) Pub. No.: US 2011/0021959 A1
(43) Pub. Date: Jan. 27, 2011

(54) WALL MOUNTABLE BACK MASSAGER

(76) Inventor: Luke Brown, Seattle, WA (US)

Correspondence Address: THOMAS LOOP;GRAYBEAL JACKSON LLP, 400 - 108TH AVENUE NE, SUITE 700, BELLEVUE, WA, 98004, US

(21) Appl. No.: 12/686,367

(22) Filed: Jan. 12, 2010

Related U.S. Application Data
(63) Continuation-in-part of application No. 11/611,322, filed on Dec. 15, 2006, now Pat. No. 7,645,248.

(51) Int. Cl. A61H 15/00

(52) U.S. Cl. 601/122

(57) ABSTRACT

A wall-mounted or wall-mountable back massager adapted to allow a user to self-administer a massage is disclosed. The inventive wall-mounted back massager comprises: an elongated wall mount track vertically positioned on a wall; a vertically adjustable elongated base member slidably engaged to the wall mount track; a plurality of paired wheel assemblies attached in series along the elongated base member. In this configuration, vertical movement of a person's back due to bending and straightening of their knees effects movement of the attached wheels relative to the person's back, thereby allowing the person to enjoy a self-administered massage.

### CROSS-REFERENCE TO RELATED APPLICATIONS

This application is a continuation-in-part of U.S. application Ser. No. 11/611,322 filed on Dec. 15, 2006 (pending), which application is incorporated herein by reference in its entirety for all purposes.

### TECHNICAL FIELD

The present invention relates generally to therapeutic massaging devices, and more particularly, to wall-mounted back massagers.

### BACKGROUND OF INVENTION

As is appreciated by physical therapists, massage involves the manipulation of muscle and connective tissue to enhance the function of those tissues and promote relaxation and well-being. Therapeutic massage can ease tension and reduce pain, and can also be highly effective for reducing the symptoms of arthritis, back pain, and other disorders of the muscles and/or nervous system. Massage is generally administered either by another person (such as, for example, a masseuse or a masseur) or is self-administered by means of a mechanical massaging device.

Over the years, a variety of massaging devices have been invented and marketed to those desirous of self-administered massage. Exemplary in this regard are the various massage contraptions disclosed in following U.S. patents and patent publications:

U.S. Pat. No. 5,174,282 to Bleggi discloses a back massage apparatus for use by a user while in a standing position on a floor in close proximate relation to a fixed vertical surface. The back massage apparatus comprises a plurality of spaced elastomeric balls (for alternately applying and releasing pressure on the back muscles of the user) rotatably supported by a carrier system that is attached to the fixed vertical surface. The balls are positioned between the user's back and the vertical surface with the balls orientated on opposite sides of the spinal column. Vertical movement of the user's back due to bending of the knees effects movement of the balls relative to the user's back.

U.S. Patent Application No. U.S. 2002/0013541 to Marcantoni discloses a massaging device (to be inserted in the back of a massage chair or the like) that comprises a frame suitable to support massage wheels which are rotationally actuated by at least one gearmotor. The massage wheels are directly connected to the shaft of the gearmotor by way of an element suitable to produce an oscillation of the massage wheels so that the longitudinal axis of the massage wheels oscillates, during the rotation of the wheels, with respect to the axis that passes through the center of the wheels.

U.S. Patent Application No. US2002/0193715 to Slack discloses a wall-mounted back massager that comprises a stationary hardwood ball vertically positioned at a user selected height. The user is thus able to press and move their back against the ball, and is doing is able to apply therapeutic pressure to relieve back, shoulder and neck tension.

U.S. Pat. No. 6,808,500 to Cheng-Yi et al. discloses a roller massager that comprises a seat body, a drive motor, a sliding seat, a second drive motor and rocker arm type massaging roller sets. The massaging roller sets are pivoted at the ends of a drive rod and is driven by the second drive motor indirectly, which is characterized by two pilot end heads eccentrically fitted at the two ends of the drive rod respectively, while a pilot end head at one end is provided with a radial slot, together with a bolt installed on the drive rod, that pilot end head can rotate itself depending on the different rotating directions of the drive rod, thus change the relative attitude to the pilot end head at another end. In this configuration, the roller sets can achieve motions of rising and sinking, as well as automatic switching between two massaging modes of rocking and kneading.

U.S. Pat. No. 6,832,991 to Inada et al. discloses a massaging apparatus in which the position of a specific portion of a user's body (such as a user's shoulder) with respect to the massaging apparatus can be determined automatically and accurately in a simple construction. The massaging apparatus includes a supporting arm having a therapeutic member pivotally supported thereon and freely movable along the user's body. The position of the specific portion of the user's body with respect to the massaging apparatus is determined from the relation between the vertical position of the supporting arm and the pivotal position of the supporting arm. A pivotal movement detecting system is provided that detects when the supporting arm reaches a prescribed range of pivotal movement.

U.S. Patent Publication No. 2005/0148912 to Liao discloses a massaging wheel assembly that comprises two base frames pivotally connected in parallel to a sliding carrier slidably movable in a sliding track, each base frame having a wheel axle at the front end and a pivot pin at the rear end, two supplementary frames respectively pivoted to the pivot pins at the rear ends of the base frames, each supplementary frame having two wheel axles at the ends, two main massaging wheels respectively pivoted to the wheel axles at the front ends of the base frames, and four supplementary massaging wheels respectively pivoted to the wheel axles at the ends of the supplementary frames.

U.S. Pat. No. 7,014,620 to Kim discloses a lie-down massager that comprises a frame having an elongated top panel with an elongated opening, a rider below the top panel, a guide member movably engaged between the frame and the rider to enable the rider to make a horizontal reciprocation relative to the frame, a lifter moving vertically relative to the rider, and a roller gear engaged to the rider. The roller gear is engaged to a vertical rack gear in an opening of an engagement body extending from the lifter so the roller gear rotation enables the lifter to make a vertical reciprocation. Massage bumps attached to the top portion of the lifter move vertically and/or horizontally along the elongated top opening of the elongated top panel of the frame by the lifter and the rider.

U.S. Pat. No. 7,081,098 to Kim discloses a lie-down massager that comprises a base frame having a top panel, a rider provided below the top panel of the base frame, a guide member movably engaged between the base frame and the rider to enable the rider to make a horizontally reciprocal movement relative to the base frame, massage bumps that move vertically along an elongated top opening of the elongated top panel of the base frame, and a lifter that holds the massage bumps and adjusts the height of the massage bumps. The lifter includes a top plate, a bottom plate, a fluid operated cylinder fixed to the bottom plate, and a spring fixed between the top plate and the bottom plate. The fluid operated cylinder has a cylinder shaft that is moved by pressurized fluid overcoming the force of the spring, and a guide shaft and a guide bearing that have a square cross section.

Although a vast variety of self-administered back massagers are known to exist, there is still a need in the art for new and improved back massagers, especially in terms of back massagers that have reduced size, bulkiness, cumbersomeness, and cost. There is also a need in the art for new and improved back massagers that are gearless and motorless. There is still a further need in the art for back massagers that are readily attachable to a fixed vertical surface, and are readily adjustable to a user selected height. The present invention fulfills these needs and provides for further related advantages.

### SUMMARY OF THE INVENTION

In brief, the present invention is directed to a wall-mounted or wall-mountable back massager adapted to allow a user to self-administer a massage. The inventive wall-mounted or wall-mountable back massager comprises: an elongated wall mount track for positioning the wall-mountable back massager on a wall; a vertically adjustable elongated base member having an arcuate top surface slidably engaged to the wall mount track, and at least four pairs of wheels rotatably positioned at different elevations about the elongated base member.

These and other aspects of the present invention will become more evident upon reference to the following detailed description and attached drawings. It is to be understood, however, that various changes, alterations, and substitutions may be made to the specific embodiments disclosed herein without departing from their essential spirit and scope. Finally, it is expressly provided that all of the various references cited herein are incorporated herein by reference in their entireties for all purposes.

### BRIEF DESCRIPTION OF THE DRAWINGS

The drawings are intended to be illustrative and symbolic representations of certain exemplary embodiments of the present invention and as such they are not necessarily drawn to scale. In addition, and for purposes of clarity, like reference numerals have been used to designate like features throughout the several views of the drawings.

FIG. 1 shows an isometric view of a wall-mounted back massager in accordance with an embodiment of the present invention.

FIG. 2 shows an exploded view of the wall-mounted back massager of FIG. 1.

FIG. 3 shows an end view of the wall-mounted back massager in accordance with an embodiment of the present invention.

FIG. 4 shows a side elevational view of the wall-mounted back massager in accordance with an embodiment of the present invention.

FIG. 5A shows a side elevational view of the wall-mounted back massager, wherein a person is using the wall-mounted back massager in a partially squatted upright position.

FIG. 5B shows a side elevational view of the wall-mounted back massager of FIG. 5A, wherein the person is using the wall-mounted back massager in a fully upright position.

### DETAILED DESCRIPTION OF THE INVENTION

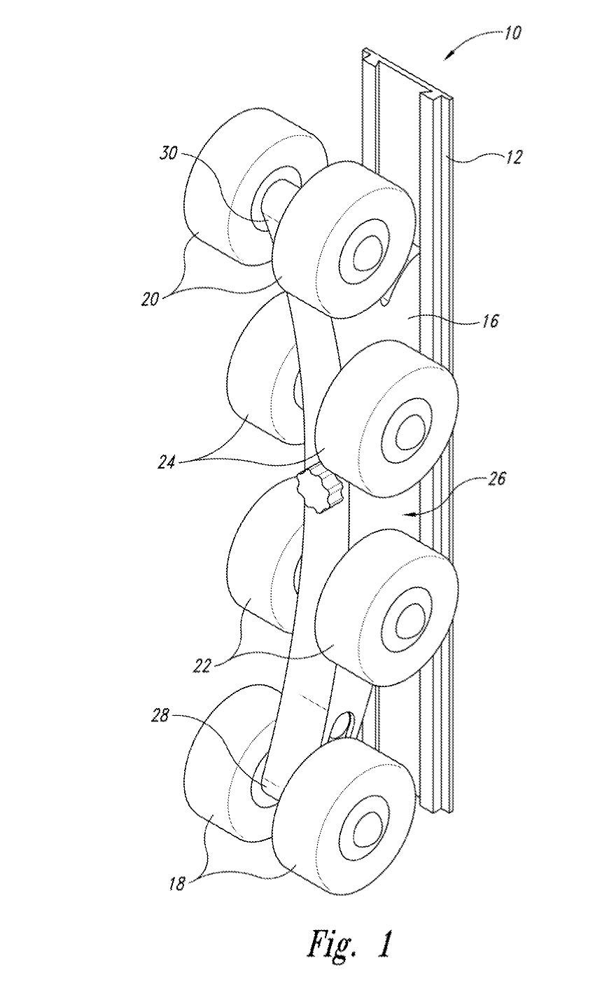

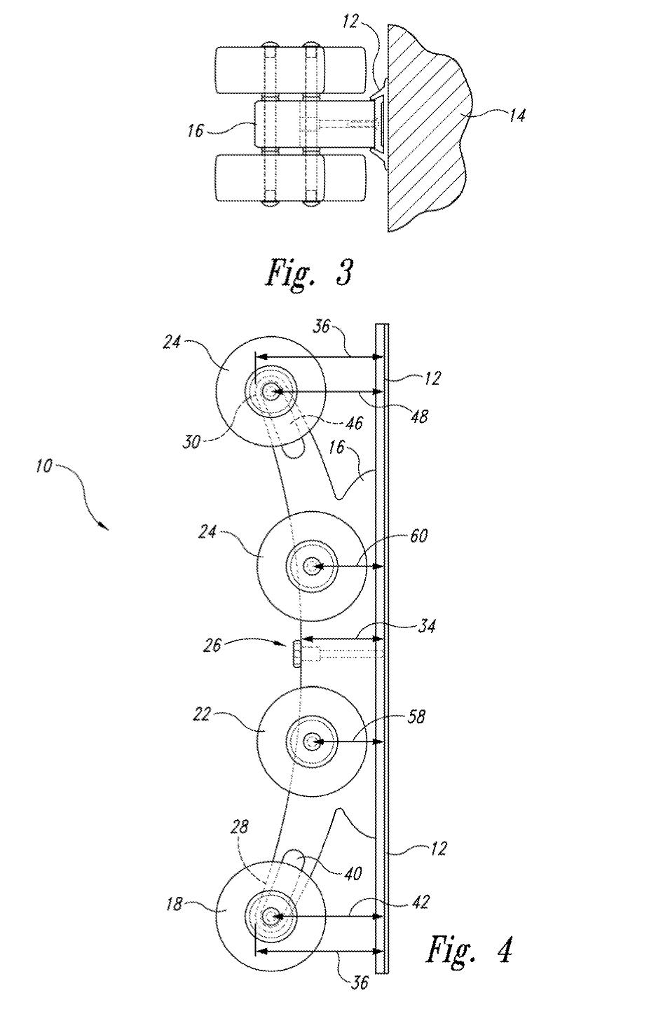

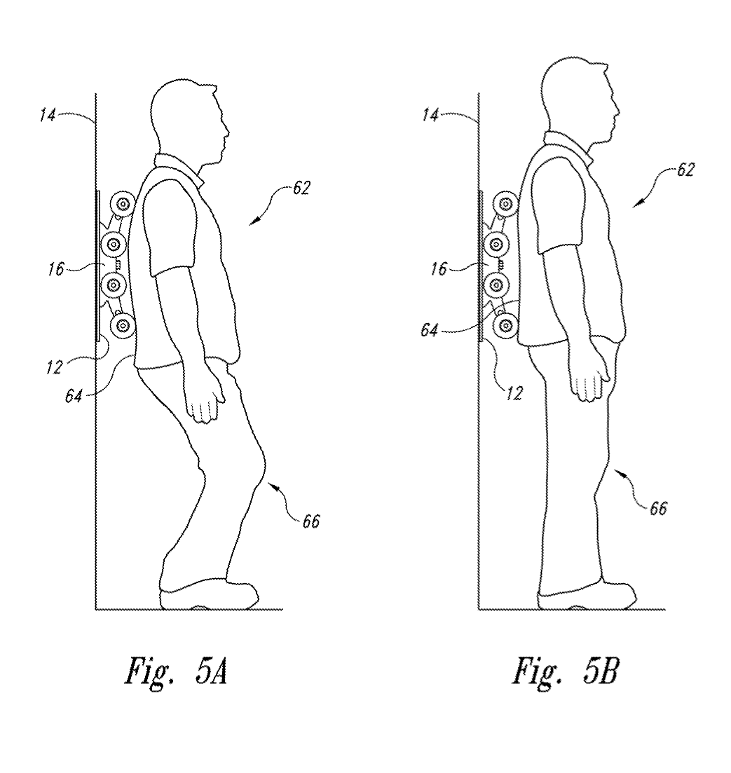

Referring now to the drawings wherein like reference numerals designate identical or corresponding elements, and more particularly to FIGS. 1, 2, 3, 4, 5A and 5B, the present invention is directed to a wall-mounted or wall mountable back massager 10 that comprises an elongated wall mount track 12 vertically positioned or positionable on a wall 14 (as shown in FIGS. 3, 5A and 5B); a vertically adjustable elongated base member 16 slidably engaged to the wall mount track 12 (vertically adjustable by means of one or more conventional stop pins, tension screws, or wing nut configuration—not all shown); and at least a first, second, third, and fourth pairs of wheels 18, 20, 22, 24 attached in series along the elongated base member 16 and at different elevations with respect to the elongated wall mount track 12.

As shown, the vertically adjustable elongated base member 16 is configured to slidably engage to the wall mount track 12. The elongated base member 16 has a middle section 26 positioned between first and second end sections 28, 30. The first and second end sections 28, together with the middle section 26 define an arcuate top surface 32. The arcuate top surface 32 at the middle section 26 defines a first top surface distance 34 (away from the elongated wall mount track 12). The arcuate top surface 32 at the first and second end sections 28, 30 are each a second top surface distance 36 (away from the elongated wall mount track 12). Because of the curved nature associated with the top arcuate surface 32, the first top surface distance 34 is much less than the second top surface distance 36 at the first and second end sections 28, 30, thereby enabling proper placement (relative to the position of a user's back) of the first, second, third, and fourth pairs of wheels 18, 20, 22, 24 as described below.

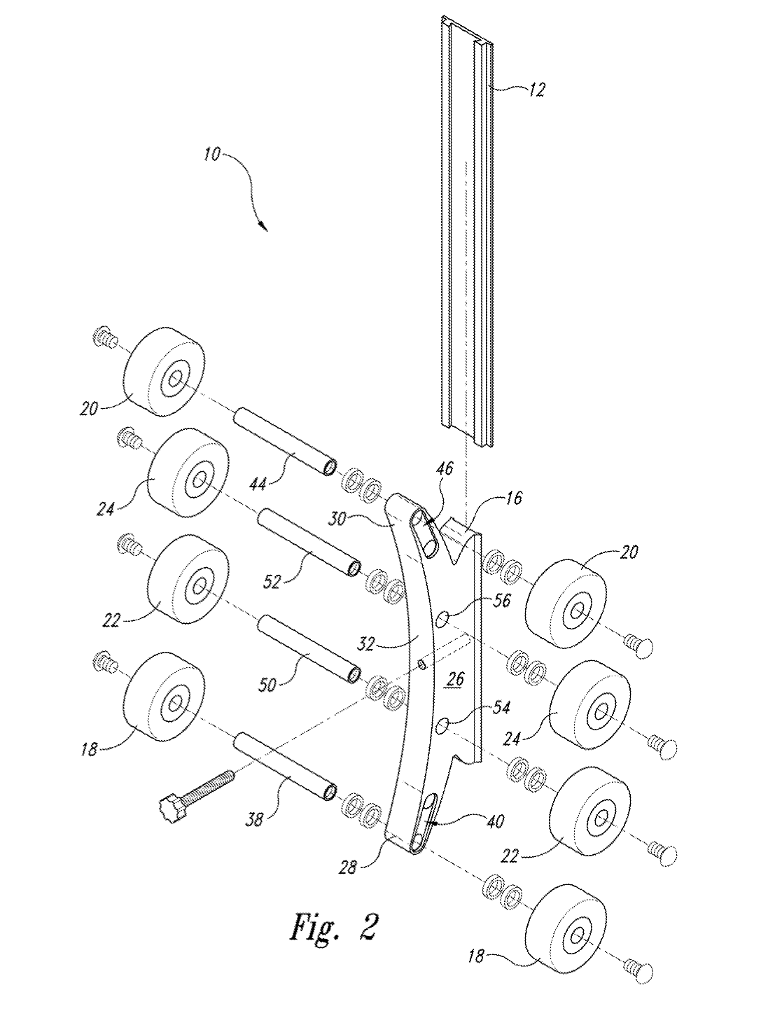

As shown best shown in FIG. 2, a first pair of confronting and axially aligned wheels 18 are rotatably attached to a first wheel axle 38, wherein the first wheel axle 38 is received through a first receiving slot 40 located at the first end section 28 of the elongated base member 16 such that (i) the first wheel axle 38 is perpendicular to the elongated base member 16 and positioned a first wheel axle distance 42 away from the elongated wall mount track 12, and (ii) each wheel of the first pair of wheels 18 is freely rotatable when the wall-mountable back massager 10 is mounted on the wall 14.

As also best shown in FIG. 2, a second pair of confronting and axially aligned wheels 20 rotatably attached to a second wheel axle 44, wherein the second wheel axle 44 is received through a second receiving slot 46 located at the second end section 30 of the elongated base member 16 such that (i) the second wheel axle 44 is perpendicular to the elongated base member 16 and positioned a second wheel axle distance 48 away from the elongated wall mount track 12, and (ii) each wheel of the second pair of wheels 24 is freely rotatable when the wall-mountable back massager 10 is mounted on the wall 14.

Finally, and as also best shown in FIG. 2, the inventive back massager 10 also includes at least a third and fourth pair of confronting and axially aligned wheels 22, 24 (noted above) that are also rotatably attached to respective third and fourth wheel axles 50, 52, wherein the third and fourth wheel axles 50, 52 are received through respective third and fourth through-holes 54, 56 positioned along the middle section 26 of the elongated base member 16 such that (i) the third and fourth wheel axles 50, 52 are perpendicular to the elongated base member 16 and positioned third and fourth wheel axle distances 58, 60 away from the elongated wall mount track 12, and (ii) each wheel of the third and fourth pair of wheels 22, 24 is freely rotatable when the wall-mountable back massager 10 is mounted on the wall 14.

In certain preferred embodiments, the first and second wheel axle distances 58, 60 (away the elongated wall mount track 12) are each about the same, whereas the third and fourth wheel axle distances 42, 48 (away from the elongated wall mount track 12) are each about the same and less than the first and second wheel axle distances 58, 60 (away the elongated wall mount track).

The wall mount track 12 and base member 16 may be made of a hard wood, but are preferably made of a rigid plastic such as, for example, a polyethylene or a polycarbonate. The wall mount track 12 is generally attached to the wall 14 by means of one or more fasteners (not shown) such as, for example, screws or rivets; however, it may be attached by means of an adhesive. Finally, the wheels 18, 20, 22, 24 are preferably doughnut-shaped and made of a rubber or a hard wood; however, they may be spherical and may be made of another rigid material such as plastic or metal.

In view of the foregoing, it is readily apparent that the inventive wall-mounted back massager 10 may be used by a person 62 standing in close proximity thereto (meaning the person's back 64 is in contact with the rotatably wheels 18, 20, 22, 24. More specifically, and as best shown in FIGS. 5A and 5B, vertical movement of the person's back 64 due to bending and straightening of the knees 66 (while leaning against the wall-mounted back massager 10) effects movement of each of the wheels 18, 20, 22, 24, thereby providing the person 62 with a self-administered massage.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

I claim:

1. A wall-mountable back massager, comprising:
an elongated wall mount track for positioning the wall-mountable back massager on a wall;
an elongated base member slidably engaged to the wall mount track, wherein the elongated base member has a middle section positioned between first and second end sections, and wherein the first and second end sections together with the middle section define an arcuate top surface, and wherein the arcuate top surface at the middle section is a first top surface distance away from the elongated wall mount track, and wherein the arcuate top surface at the first and second end sections are each a second top surface distance away from the elongated wall mount track, and wherein the first top surface distance is less than the second top surface distance;
a first pair of confronting and axially aligned wheels rotatably attached to a first wheel axle, wherein the first wheel axle is received through a first receiving slot located at the first end section of the elongated base member such that (i) the first wheel axle is perpendicular to the elongated base member and positioned a first wheel axle distance away from the elongated wall mount track, and (ii) each wheel of the first pair of wheels is freely rotatable when the wall-mountable back massager is mounted on the wall;
a second pair of confronting and axially aligned wheels rotatably attached to a second wheel axle, wherein the second wheel axle is received through a second receiving slot located at the second end section of the elongated base member such that (i) the second wheel axle is perpendicular to the elongated base member and positioned a second wheel axle distance away from the elongated wall mount track, and (ii) each wheel of the second pair of wheels is freely rotatable when the wall-mountable back massager is mounted on the wall;
at least a third and fourth pair of confronting and axially aligned wheels rotatably attached to respective third and fourth wheel axles, wherein the third and fourth wheel axles are received through respective third and fourth through-holes positioned along the middle section of the elongated base member such that (i) the third and fourth wheel axles are perpendicular to the elongated base member and positioned third and fourth wheel axle distances away from the elongated wall mount track, and (ii) each wheel of the third and fourth pair of wheels is freely rotatable when the wall-mountable back massager is mounted on the wall; and
wherein the first and second wheel axle distances away the elongated wall mount track are each about the same, and wherein the third and fourth wheel axle distances away from the elongated wall mount track are each about the same and less than the first and second wheel axle distances away the elongated wall mount track.

2. The wall-mountable back massager of claim 1 wherein the wall mount track further comprises an inwardly protruding channel positioned lengthwise along the elongated wall mount track, and wherein the elongated base member further comprises an outwardly protruding rail positioned lengthwise along the elongated base member, and wherein the inwardly protruding channel is configured to slidably engage the outwardly protruding rail.

3. The wall-mountable back massager of claim 2 wherein the back massager is gearless and motorless.
